(19) United States
(12) Patent Application Publication
(10) Pub. No.: US 2014/0115662 A1
(43) Pub. Date: Apr. 24, 2014

(54) Mechanism for Detecting Human Presence Using Authenticated Input Activity Timestamps

(71) Applicants: Erik J. Johnson, Portland, OR (US); Jasmeet Chhabra, Hillsboro, OR (US); Steve Orrin, Santa Clara, CA (US); Travis T. Schluessler, Hillsboro, OR (US); Stephen D. Goglin, Hillsboro, OR (US)

(72) Inventors: Erik J. Johnson, Portland, OR (US); Jasmeet Chhabra, Hillsboro, OR (US); Steve Orrin, Santa Clara, CA (US); Travis T. Schluessler, Hillsboro, OR (US); Stephen D. Goglin, Hillsboro, OR (US)

(21) Appl. No.: 14/144,757

(22) Filed: Dec. 31, 2013

Related U.S. Application Data
(63) Continuation of application No. 12/209,763, filed on Sep. 12, 2008.
(60) Provisional application No. 61/055,862, filed on May 23, 2008.

(51) Int. Cl. G06F 21/30

(52) U.S. Cl. CPC G06F 21/30
USPC 726/2

(57) ABSTRACT

When a service request associated with an initiated online service transaction is received, an attestation identifying a human-input activity is requested. Upon receiving a signature attesting the human-input activity, the previously initiated service transaction is authenticated based at least in part on the signature.

This application claims priority to Provisional Application No. 61/055,862 filed on May 23, 2008.

### FIELD

Embodiments of the invention relate to online service transactions, and more particularly to detecting human presence during a service transaction.

### BACKGROUND

Many Internet service providers require (or desire) to know that a human is present during a service transaction. For example:
Online ticket brokers, such as TicketMaster, want to know that a human is purchasing tickets to ensure that a scalping “bot” is not buying all of the tickets only to sell them later on the black market.
Craigslist and email providers want to know that a human is posting a new article or signing up for a new account to ensure its service is not being used as a vehicle for “SPAM”.
   Today, human presence, when checked, is checked with a CAPTCHA (Completely Automated Public Turing test to tell Computers and Humans Apart). A typical CAPTCHA is a distorted image that supposedly only a human can understand. CAPTCHAs, however, present a frustrating user interface and some CAPTCHAs can be broken with software.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a hardware platform according to various embodiments.

FIG. 2 is a flow diagram illustrating a process according to various embodiments.

FIG. 3 is a block diagram illustrating a suitable computing environment for practicing various embodiments described herein.

### DETAILED DESCRIPTION

As provided herein, methods, apparatuses, and systems enable authentication of service transactions based on activity timestamps and/or keystroke comparisons to ensure human presence during a service transaction. Service providers (e.g., Ticketmaster, Google and other advertisers, Craigslist, blogs, email providers, etc.) often desire to detect whether a human is present during an online service transaction. Some service providers (stock brokers, eCommerce, banks, online games, etc.) additionally desire to detect what the human actually typed. Capturing such information would allow service providers to detect click fraud, lessen SPAM email, mitigate pump-and-dump ‘viruses,’ detect cheating, etc.

A manageability engine on a hardware platform can record a timestamp to indicate when a user last pressed a key on the keyboard or clicked a button on the mouse. A timestamp, in this regard, is any monotonically increasing counter. It may correspond to the actual time of day, or it may simply indicate that user activity has occurred. Detecting the presence of a human user based on a hardware-recorded keyboard/mouse timestamp is more tamper-resistant than CAPTCHAs (which are software) and more user friendly than CAPTCHAs (e.g., simply click the mouse).

The manageability engine may also record keystrokes typed by a user to indicate what a user typed. Determining what a user is typing based on a hardware-recorded keystroke log provides additional and/or alternative tamper-resistance compared to hardware-recorded timestamps.

Described herein is a hardware platform with the ability to (1) timestamp or record the last human-input activity (e.g., keyboard click or mouse click) and (2) attest to the validity of these timestamps or keystroke recordings to detect human presence. These two platform capabilities are used to aid in the detection of automated forms of fraud as follows:
After a user interacts with an online service provider, embodiments provide the attested activity timestamp and/or keystroke log to the service provider.
The service provider determines whether the activity timestamp and/or keystroke log was correlated to the service request.

Active Management Technology (AMT) offered by Intel Corporation of Santa Clara, Calif. is a hardware-based technology that facilitates remote out-of-band (OOB) management of computers by use of a secondary processor located on the motherboard. This secondary processor located on the motherboard is called the Manageability Engine (ME). The AMT firmware, which runs on the ME, is stored in the same Serial Peripheral Interface (SPI) flash memory component used to store the BIOS and is generally updated along with the BIOS. By physically separating the hardware for the ME from the central processing unit, the ME is rendered inaccessible to users. In other words, the ME is secure and cannot be hacked, compromised or tampered with using traditional means.

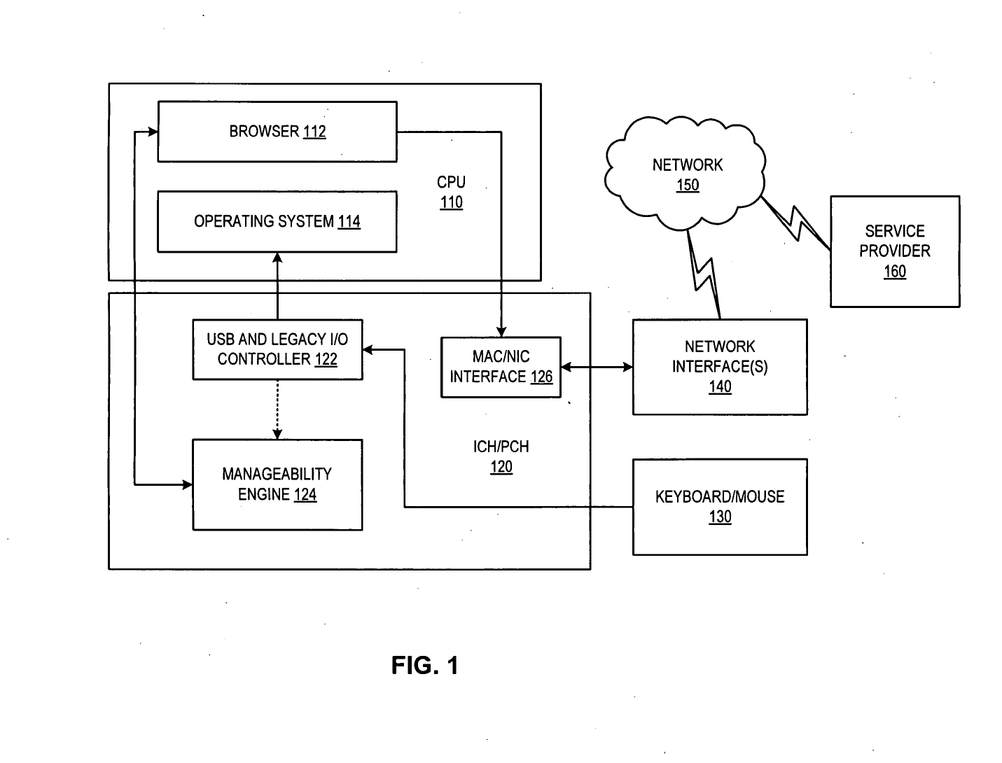

Some embodiments described herein make use of a Manageability Engine (ME) such as the one described above. FIG. 1 illustrates an example solution for authenticating online service transactions, according to various embodiments, using a Managability Engine (ME) 124 located on input/output (I/O) and/or Platform Controller Hub (ICH/PCH) 120. When a user initiates an online service transaction, browser 112 requests attestation for a human-input activity. In various embodiments, attestation includes a signature from the Manageability Engine 124 confirming a human-input activity (such as a keystroke or mouse click from keyboard/mouse 130). In some embodiments, the attestation includes a timestamp generated by Manageability Engine 124. For example, when a user logs a keystroke or mouse click via keyboard/mouse 130, the event triggers a signal to USB and/or legacy I/O controller 122. Typically, keyboard/mouse events are communicated from I/O controller 122 to operating system 114. However, in various embodiments, a dedicated hardware connection to Manageability Engine 124 allows Universal Serial Bus (USB) and/or legacy I/O controller 122 to communicate a notification of the keyboard/mouse event to Manageability Engine 124. In some embodiments, ME 124 records the time at which the event notification was received, creating a timestamp. In other embodiments the ME 124 records the keystrokes for later comparison. In yet other embodiments, ME 124 records a combination of the time at which an event notification was received and the keystrokes. Thus, ME 124 is able to return a timestamp of the last keyboard/mouse activity and/or a log of the keystrokes received in response to receiving a request from browser 112.

ME 124 has credentialing capabilities that can be used with a timestamp and/or keystroke log in response to a request from browser 112. For example, various known cryptographic protocols may be used to generate a signature that verifies the authenticity of ME 124. More specifically, ME 124 is capable of generating an anonymous signature using a protocol such as Direct Anonymous Attestation (DAA). An anonymous signature can be verified as originating from an authentic manageability engine without specifically identifying the particular manageability engine (e.g., ME 124) that generated the signature. Alternatively, ME 124 is capable of generating a non-anonymous signature using a protocol such as Transport Layer Security (TLS). One of skill in the art will appreciate that other anonymous and non-anonymous protocols may be used in various embodiments without departing from the scope of the invention described herein.

Upon receiving an anonymously or non-anonymously signed timestamp of the last keyboard/mouse activity and/or keystroke comparison from ME 124, browser 112 supplies the human-input activity indication and credentials (e.g., signature) to the service provider via Media Access Control (MAC)/Network Interface Card (NIC) interface 126 and network interface 140. The service provider then uses the credentials to authenticate the online service transaction.

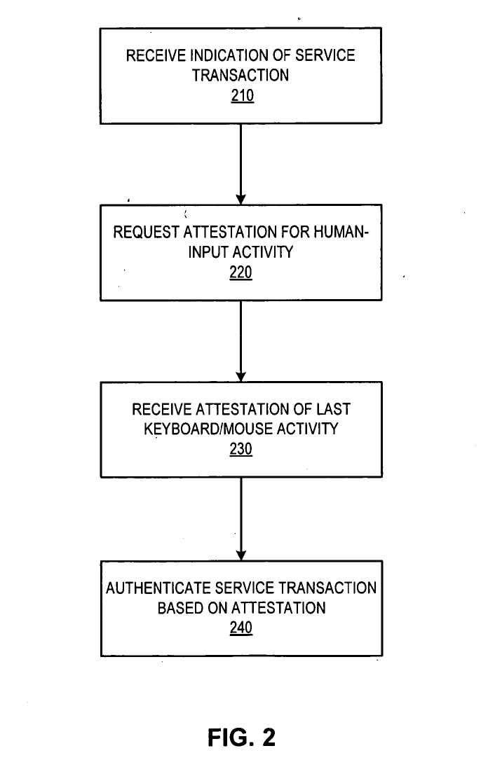

FIG. 2 is a flow-diagram illustrating a process for detecting human presence during an online service transaction. An indication of a newly initiated service transaction is received 210 (e.g., a page load request, etc.). In response, a request for attestation of a human-input activity is generated and sent to a manageability engine 220. In various embodiments, the request could be sent to other secure locations such as, for example, a trusted platform module, a secure partition, a secure container, etc.

In response to the request, an attestation of the last known keyboard/mouse activity is received 230. The attestation includes a signed timestamp and/or keystroke comparison in various embodiments. For example, if a service provider simply desires to know if a human user is present during a service transaction, a signed timestamp can verify recent keyboard/mouse activity by a user. In some embodiments, the attestation could be a signature of the actual keyboard or mouse activity. For example, if a service provider desires to know if a particular string of characters was typed by a user, the manageability engine could verify the string was indeed typed by the user (based on a log of keystrokes from a USB and/or legacy I/O controller) and provide a signed, binary “matched or not matched” response to the service provider. If the manageability engine determines that a particular string of characters was not actually typed, the service provider may filter and/or cancel the initiated service transaction.

After receiving attestation, the service provider authenticates the service transaction based at least in part on the attestation 240. For example, if a service provider desires to detect presence of an actual human user and receives an anonymously signed timestamp, the timestamp can be compared to a threshold to determine if the timestamp is temporally correlated to the initiation of the service request. If there is a correlation, then presence of a human user is determined to be authentic. Otherwise, the service transaction is determined to be fraudulent. If the service provider desires to know if a particular string of characters was typed by a human user, a received signature from the manageability engine verifies that the string of characters was typed. When the service provider receives a signature in response, then the service provider determines if the signature corresponds to a positive (“matched”) or negative (“not matched”) response and can take appropriate action based on that result.

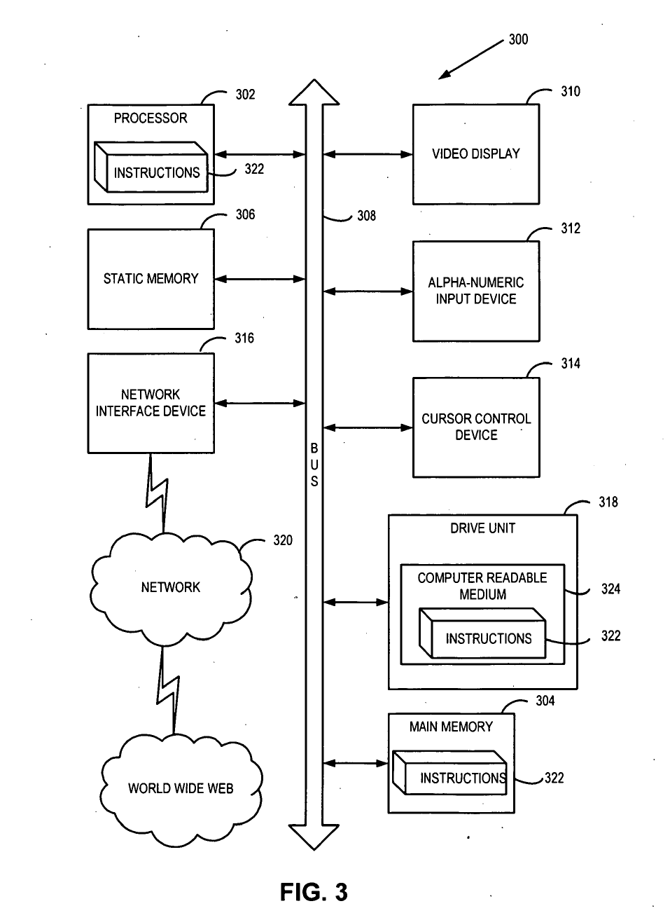

FIG. 3 illustrates a diagrammatic representation of a machine in the exemplary form of a computer system 300 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 300 includes a processor 302, a main memory 304 (e.g., read-only memory (ROM), flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a secondary memory 318 (e.g., a data storage device), which communicate with each other via a bus 308.

Processor 302 represents one or more general-purpose processing devices such as a microprocessor, central processing unit, or the like. More particularly, the processor 302 may be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processor 302 may also be one or more special-purpose processing devices such as an application specific integrated circuit (ASIC), a field programmable gate array (FPGA), a digital signal processor (DSP), network processor, or the like. Processor 302 is configured to execute the processing logic for performing the operations and steps discussed herein.

The computer system 300 may further include a network interface device 316. The computer system 300 also may include a video display unit 310 (e.g., a liquid crystal display (LCD) or a cathode ray tube (CRT)), an alphanumeric input device 312 (e.g., a keyboard), and a cursor control device 314 (e.g., a mouse).

The secondary memory 318 may include a machine-readable storage medium (or more specifically a computer-readable storage medium) 324 on which is stored one or more sets of instructions (e.g., software 322) embodying any one or more of the methodologies or functions described herein. The software 322 may also reside, completely or at least partially, within the main memory 304 and/or within the processing device 302 during execution thereof by the computer system 300, the main memory 304 and the processing device 302 also constituting machine-readable storage media. The software 322 may further be transmitted or received over a network 320 via the network interface device 316.

While the machine-readable storage medium 324 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine readable storage medium” shall accordingly be taken to include, but not be limited to, solid-state memories, and optical and magnetic media.

Various operations or functions are described herein, which may be implemented or defined as software code or instructions. Such content may be directly executable (“object” or “executable” form), source code, or difference code. Software implementations of the embodiments described herein may be provided via an article of manufacture with the code or instructions stored thereon, or via a method of operating a communication interface to send data via the communication interface. A machine or computer readable storage medium may cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

The present invention also relates to a system for performing the operations herein. This system may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CDROMs, and magnetic-optical disks, read-only memories (ROMs), random access memories (RAMs), erasable programmable read-only memories (EPROMs), electrically erasable programmable read-only memories (EEPROMs), magnetic or optical cards, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized system to perform the required operations of the method. Structure for a variety of these systems will appear as set forth in the description below. In addition, the present invention is not described with reference to any particular programming language or operating system. It will be appreciated that a variety of programming languages may be used to implement the teachings of the invention as described herein, and the teachings may be implemented within a variety of operating systems.

The operations and functions described herein can be implemented as software modules, hardware modules, special-purpose hardware (e.g., application specific hardware, application specific integrated circuits (ASICs), digital signal processors (DSPs), etc.), embedded controllers, hardwired circuitry, etc.

Aside from what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

1-20. (canceled)

21. At least one computer-readable medium comprising instructions that when executed on a processor configure the processor to:
receive one or more user input events having one or more associated timestamps; and
determine that a human generated the one or more user input events, wherein the determination is based at least in part on the one or more timestamps.

22. The at least one computer-readable medium of claim 21, wherein the one or more user input events comprises a keyboard input, a mouse click, or a mouse movement.

23. The at least one computer-readable medium of claim 21, wherein the one or more user input events comprises a key press, a key release, a mouse button press, or a mouse button release.

24. The at least one computer-readable medium of claim 21, wherein
a first user input event is associated with initiation of a service request, the first user input event being associated with a first timestamp;
a second user input event comprises a keyboard input, a mouse click, or a mouse movement, the second user input event being associated with a second timestamp; and
wherein the instructions further configure the processor to:
temporally correlate a difference between the first timestamp and the second timestamp to a threshold.

25. The at least one computer-readable medium of claim 24, wherein
the initiation of the service request comprises a request to generate a form to receive user input.

26. An apparatus comprising:
a processor; and
a memory coupled to the processor, wherein the memory comprises instructions that configure the processor to:
receive one or more user input events having one or more associated timestamps; and
determine that a human generated the one or more user input events, wherein the determination is based at least in part on the one or more timestamps.

27. The apparatus of claim 26, wherein the one or more user input events comprises a keyboard input, a mouse click, or a mouse movement.

28. The apparatus of claim 26, wherein the one or more user input events comprises a key press, a key release, a mouse button press, or a mouse button release.

29. The apparatus of claim 26, wherein
a first user input event is associated with initiation of a service request, the first user input event being associated with a first timestamp;
a second user input event comprises a keyboard input, a mouse click, or a mouse movement, the second user input event being associated with a second timestamp; and
wherein the instructions further configure the processor to:
temporally correlate a difference between the first timestamp and the second timestamp to a threshold.

30. The apparatus of claim 29, wherein
the initiation of the service request comprises a request to generate a form to receive user input.

31. At least one computer-readable medium comprising instructions that when executed on a processor configure the processor to:
collect one or more user input events having one or more associated timestamps; and
determine that a human generated the one or more user input events, wherein the determination is based at least in part on the one or more timestamps.

32. The at least one computer-readable medium of claim 31, wherein the processor collects the at least one user input event by recording mouse click, mouse movement or keystroke data.

33. The at least one computer-readable medium of claim 31, wherein the one or more user input events comprises a keyboard input, a mouse click, or a mouse movement.

34. The at least one computer-readable medium of claim 31, wherein the one or more user input events comprises a key press, a key release, a mouse button press, or a mouse button release.

35. The at least one computer-readable medium of claim 31, wherein
a first user input event is associated with initiation of a service request, the first user input event being associated with a first timestamp;
a second user input event comprises a keyboard input, a mouse click, or a mouse movement, the second user input event being associated with a second timestamp; and
wherein the instructions further configure the processor to:
temporally correlate a difference between the first timestamp and the second timestamp to a threshold.

36. The at least one computer-readable medium of claim 35, wherein
the initiation of the service request comprises a request to generate a form to receive user input.

37. An apparatus comprising:
a processor; and
a memory coupled to the processor, wherein the memory comprises instructions that configure the processor to:
collect one or more user input events having one or more associated timestamps; and
determine that a human generated the one or more user input events, wherein the determination is based at least in part on the one or more timestamps.

38. The apparatus of claim 37, wherein the processor collects the at least one user input event by recording mouse click, mouse movement or keystroke data.

39. The apparatus of claim 37, wherein the one or more user input events comprises a keyboard input, a mouse click, or a mouse movement.

40. The apparatus of claim 37, wherein the one or more user input events comprises a key press, a key release, a mouse button press, or a mouse button release.

41. The apparatus of claim 37, wherein
a first user input event is associated with initiation of a service request, the first user input event being associated with a first timestamp;
a second user input event comprises a keyboard input, a mouse click, or a mouse movement, the second user input event being associated with a second timestamp; and
wherein the instructions further configure the processor to:
temporally correlate a difference between the first timestamp and the second timestamp to a threshold.

42. The apparatus of claim 41, wherein
the initiation of the service request comprises a request to generate a form to receive user input.

43. A method comprising:
receiving one or more user input events having one or more associated timestamps; and
determining that a human generated the one or more user input events, wherein the determination is based at least in part on the one or more timestamps.

44. A method comprising:
collecting one or more user input events having one or more associated timestamps; and
determining that a human generated the one or more user input events, wherein the determination is based at least in part on the one or more timestamps.
